(19) United States
(12) Patent Application Publication
(10) Pub. No.: US 2005/0250551 A1
(43) Pub. Date: Nov. 10, 2005

(54) Notification about an event

(75) Inventor: Seppo Ilmari Helle, Paimio (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/842,640

(22) Filed: May 10, 2004

(51) Int. Cl. H04B 1/38; H04M 1/00

(52) U.S. Cl. 455/567; 455/575.3; 455/550.1

(57) ABSTRACT

A method of notifying a user of a mobile electronic device about an unchecked event monitors whether a user checks the event and whether at least one further predetermined condition is met. Whenever the at least one further predetermined condition is met while a user has not yet checked the event, a notification about the event is provided. A mobile electronic device is shown can use the method and it can be carried out by a software program product for such a mobile electronic device.

### FIELD OF THE INVENTION

The invention relates to a method of notifying a user of a mobile electronic device about an unchecked event. The invention relates equally to such a mobile electronic device and to a software program product for such a mobile electronic device.

### BACKGROUND OF THE INVENTION

Various mobile electronic devices enable a user to make use of certain events. A mobile communication device, for example, may enable a user to make use of phone calls, short messages, appointment reminders, etc.

Frequently, however, a user will not notice an event at the moment it occurs. Even if the incidence of an event is accompanied by notification tones, a user may not notice the event, for instance because of a noisy environment or because the mobile electronic device was left at some distance for a while.

A mobile communication device therefore typically informs the user about such an event in addition by displaying a notification about the event on a display of the mobile communication device. The notification may be for instance a text or an icon indicating the type of the event. The notification stays on the display until a user checks the event.

A user may not notice such a static notification for some time, though. Current color screens are particularly problematic in this respect, as they are dark and difficult to read without backlight. The backlight cannot be turned on for extended periods of time in order to overcome this problem due to the limited battery capacity of mobile electronic devices.

From wired phones, it is further known to indicate a missed phone call by means of a flashing light. In a mobile electronic device, however, a continuously flashing light would equally increase the battery consumption significantly.

### SUMMARY OF THE INVENTION

It is an object of the invention to improve the user experience with regard to the notification of events occurring at a mobile electronic device.

A method of notifying a user of a mobile electronic device about an unchecked event is proposed. The method comprises monitoring whether a user checks this event. The method moreover comprises monitoring whether at least one further predetermined condition is met. The method finally comprises providing a notification about the event whenever the at least one further predetermined condition is met while a user has not yet checked the event.

In addition, a mobile electronic device is proposed, which comprises a user interface and a processing component. The processing component is adapted to monitor whether a user checks an unchecked event. The processing component is moreover adapted to monitor whether at least one further predetermined condition is met. The processing component is moreover adapted to cause a provision of a notification about the event via the user interface, whenever the at least one further predetermined condition is met while a user has not yet checked the event.

Finally, a software program product in which a software code for notifying a user of a mobile electronic device about an unchecked event is stored is proposed. When running in a processing component of the mobile electronic device, the software code monitors whether a user checks the event and whether at least one further predetermined condition is met. The software code further causes a provision of a notification about the event whenever the at least one further predetermined condition is met while a user has not yet checked the event.

The invention proceeds from the consideration that a user could be provided with a notification about an event not only continuously, but also in intervals. It is therefore proposed that a notification is provided when a certain condition is met. This notification can be provided in particular, though not exclusively, in addition to a conventional first notification by notification tones and/or to a conventional static notification. The mobile electronic device can be in particular, though not exclusively, a mobile communication device, and the event can be in particular, though not exclusively, a communication related event.

It is an advantage of the invention that it facilitates the notice of an event by a user. In contrast to the conventionally employed static notifications, the proposed occasional notification can be realized in a way which is more suited to draw the attention of a user without stressing the battery of the communication component extensively.

The predetermined condition which is to lead to the notification can be selected as desired.

In a particularly simple embodiment of the invention, the at least one condition is met when a predetermined period of time has passed after a respectively preceding notification about the event. That is, the user is notified at regular intervals about the event.

Alternatively or in addition, the at least one condition can also be met if a predetermined state of the mobile electronic device is entered. Such a predetermined state can be monitored by a suitable sensor of the mobile electronic device. A predetermined state can be for instance the beginning of a motion of the mobile electronic device monitored by a motion sensor, the usage of a keypad of the mobile electronic device and/or a change of a noise level in the environment monitored for example by a microphone of the mobile electronic device.

The notification which is provided when the predetermined condition is met can equally be of various kinds. In one embodiment of the invention, the notification comprises for example an optical notification by a visual output of the device, in particular a flashing light provided by the backlight of a display, a keypad illumination and/or a dedicated light installation, etc. The notification may also comprise any other visual notification, for example a change in the appearance of the cover of the phone. In another embodiment of the invention, the notification comprises an audible notification output by an audio output, like a loudspeaker of the mobile electronic device or by a loudspeaker connected to the mobile electronic device. In yet another embodiment of the invention, the notification comprises a vibration of the device generated by a vibration generator. If a plurality of conditions are monitored, it is also possible to associate to each condition a specific kind of notification or different combinations of notifications.

The time of provision and the type of the notification may also be determined based on a combination of various conditions. If the at least one condition comprises that a predetermined period of time has passed after a respectively preceding notification of the event, for instance, the presence or absence of a motion may determine the length of this period of time and the type of the notification.

For example, the notification may be provided more frequently, when the mobile electronic device is detected to be moving than when it is determined to be stationary. Moreover, the notification may comprise a vibration only if a motion is present. Further, notification tones may be quiet or ramping when the mobile electronic device is stationary, and louder when the mobile electronic device is determined to be in motion.

In an advantageous embodiment of the invention, the notification which is provided according to the invention is different from a first notification indicating the actual occurrence of the event. This ensures that the user of the mobile electronic device can differentiate easily between new and old events.

In a further embodiment of the invention, the provision of notifications which are provided according to the invention can be activated and deactivated by a user of the mobile electronic device. Thereby, the user can avoid being disturbed in certain situations by the notifications.

The invention is of particular advantage for use with a foldable mobile communication device, which comprises a primary display which is hidden when the device is folded and a secondary display which is not hidden when the device is folded. If the notification is provided via the secondary display, a user would not have to perform any actions with the device, like open the device, in order to be informed about an event. When attention is needed, this becomes apparent to a user simply by looking at the secondary display, which enhances the convenience for the user.

While a simple embodiment of the invention ensuring a notification at regular intervals can be implemented completely in software, a monitoring of the status of the mobile electronic device may require in addition hardware components for sensing the state of the device. Status sensing capabilities may further require an appropriate logic for deciding when a notification should be provided.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of a mobile electronic device according to a first embodiment of the invention; and

FIG. 2 is a flow chart illustrating the operation of the mobile electronic device of FIG. 1 according to an embodiment of the invention.

### DETAILED DESCRIPTION OF THE INVENTION

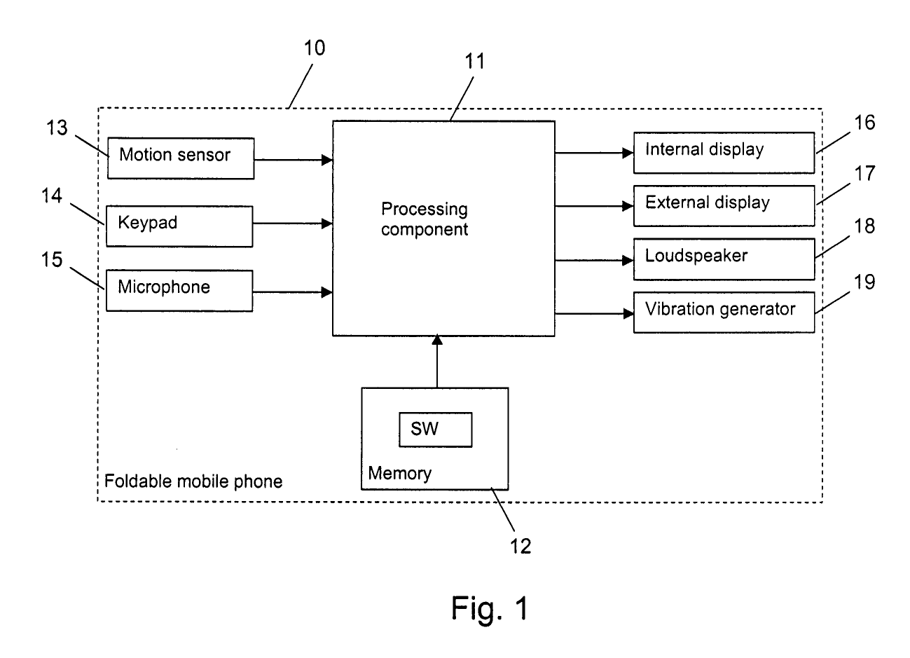

FIG. 1 is a schematic block diagram of selected components of a foldable mobile phone 10. The mobile phone 10 is an embodiment of the mobile electronic device according to the invention and allows a repeated notification of a user about a communication event.

The mobile phone 10 comprises to this end a processing component 11 running a notification software SW stored in a memory 12. The memory 12 is an embodiment of a software program product according to the invention.

The mobile phone 10 further comprises a motion sensor 13, a microphone 15 and a keypad 14, either providing an input to the processing component 11.

The mobile phone 10 moreover comprises an internal display 16, which is only visible when the mobile phone 10 is unfolded, and an external display 17 which is also visible when the mobile phone 10 is folded. Both displays 17, 18 are controllable by the processing component 11. In addition, the mobile phone comprises a loudspeaker 18 and a vibration generator 19, which are equally controllable by the processing component 11.

It is to be understood that the connection between the processing component 11 and the other depicted components 12 to 19 can be direct connections, but equally indirect connections via other components.

An incoming call and the arrival of a new short message at the mobile phone 10 are indicated to a user by notification tones output via the loudspeaker 18. When a new short message arrives at the mobile phone 10 or when an incoming phone call is not responded to by a user of the mobile phone 10, the user is further notified by a short text on the internal display 16, for instance “New message arrived” or “One missed call”, respectively.

A user of the mobile phone 10 may enable and disable repeated notifications about such communication events as desired by an input via the keypad 14.

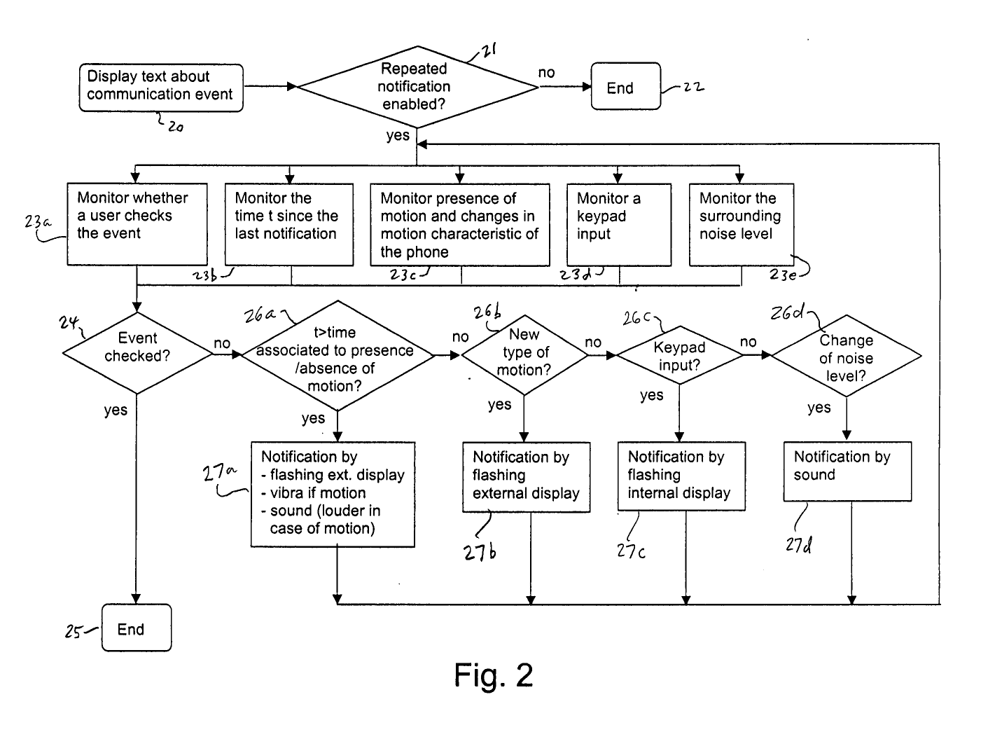

The operation of the mobile phone 10 for outputting repeated notifications about a communication event will now be explained with reference to the flow chart of FIG. 2.

The processing described in the following is only carried out after displaying or otherwise notifying the user about a communication event (step 20 in FIG. 2) if repeated notifications have been enabled by the user and as checked in a decision step 21. If not enabled, then the processing ends (step 22).

The processing component 11 runs the software SW, which monitors (steps 23a, 24) continuously whether a user checks the communication event indicated by the textual notification. Further, the software SW monitors (step 23b) the time t which has passed since the last notification was output.

In addition, the motion sensor 13 senses (step 23c) the presence of a motion and changes in the motion characteristics of the mobile phone 10 and provides corresponding indications to the processing component 11.

The keypad 14 moreover registers an input by a user and provides a corresponding indication to the processing component 11 as indicated by a step 23d.

The microphone 15, finally, determines the surrounding noise level (step 23e) and provides a corresponding indication to the processing component 11.

If the user has checked the communication event in the meantime, as determined in the step 24, the procedure for repeated notifications is stopped (step 25).

If the user has not checked the communication event so far, the software SW determines a time threshold value t1 (step 26a) based on the currently indicated presence or absence of a motion of the mobile phone 10. The value of the time threshold t1 is set higher when the mobile phone 10 is indicated to be in motion and lower when the mobile phone 10 is indicated to be stationary. In case no presence of a motion is indicated, the value of the time threshold t1 can be set, for instance, to 10 minutes.

In case the time t which has passed since the last notification was presented exceeds the determined threshold value t1, the user is notified again (step 27a) about the communication event by a flashing backlight of the external display 17 for a short period of time. If a motion of the mobile phone 10 is indicated, in addition a vibration of the mobile phone 10 is caused via the vibration generator 19 for a short period of time. Further, notification tones are output via the loudspeaker 18 for a short period of time. The notification tones are louder in case of an indicated motion of the mobile phone 10. The notification tones are clearly distinct from the notification tones used at the incidence of the communication event, so that a user can differentiate between a first notification and subsequent notifications.

In case the time t which has passed since the last notification was presented does not exceed the determined threshold value t1, but if a new motion or, more generally, a certain kind of change in the motion characteristics is indicated by the motion sensor 13, as determined in a step 26b, the user is notified again (step 27b) about the communication event by flashing the backlight of the external display for a short period of time. A new motion might indicate for instance that the mobile phone 10 has been lying on a table with a pending notification, which is now picked up by the user. Also in the case the mobile phone 10 has already been in motion, certain changes in the motion characteristics might indicate that the user starts to handle the mobile phone 10. For example, when the mobile phone 10 is located in a moving train, the mobile phone 10 has a mostly constant velocity in relation to earth, with only slow changes. When the user now starts to handle the mobile phone 10, then quick, small-scale irregular movements and accelerations can be sensed by the motion sensor 13. If a flashing light is then output immediately, it is probable that the user will pay some attention to this additional notification.

In case no new motion but a key input is indicated, as determined in a step 26c, the user is notified again (step 27c) about the communication event by flashing the backlight of the internal display 16 for a short period of time, as the internal display 16 is usually visible to a user when using the keypad 14. This notification is equally output regardless of the time passed since the last notification, since a user can be expected to be attentive to a flashing display 16 when using the keypad 14.

In case no key input is indicated, but a sudden change in the surrounding noise level is determined in a step 26d, the user is notified again (step 27d) about the communication event by notification tones via the loudspeaker 18 during a short period of time. This notification is equally output regardless of the time passed since the last notification, since a sudden increase of the noise level might indicate that a user extracted the mobile phone from a pocket, while a sudden decrease of the noise level might indicate that a user is now able to hear notification tones which might not have been audible before. The employed notification tones are again clearly distinct from the notification tones used at the incidence of the communication event, so that a user can differentiate between a first notification and subsequent notifications.

The described process is repeated, until the software SW determines (step 24) that the user has checked the indicated communication event and it is then ended (step 25).

On the whole, it becomes apparent that the presented embodiment enables a comfortable repeated notification of a user about a communication event without stressing the battery of the mobile phone 10 extensively.

While there have been shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method of notifying a user of a mobile electronic device about an unchecked event, said method comprising:
monitoring whether a user checks said event;
monitoring whether at least one further predetermined condition is met; and
providing a notification about said event whenever said at least one further predetermined condition is met while a user has not yet checked said event.

2. The method according to claim 1, wherein said at least one further predetermined condition comprises that a predetermined period of time has passed after a respectively preceding notification about said event.

3. The method according to claim 1, wherein said at least one condition comprises the entry of a predetermined state of said mobile electronic device.

4. The method according to claim 3, wherein said predetermined state is at least one of a motion of said mobile electronic device, a usage of a keypad of said mobile electronic device, and a change of a noise level surrounding said mobile electronic device.

5. The method according to claim 1, wherein said notification comprises at least one of an optical notification, a visual notification, an audible notification and a vibration of said device.

6. The method according to claim 1, wherein said notification differs from a first notification indicating an actual occurrence of said event.

7. The method according to claim 1, wherein said at least one further predetermined condition comprises a plurality of conditions, and wherein a specific type of notification to be used is associated to each of said conditions.

8. The method according to claim 1, wherein said at least one further predetermined condition comprises that a predetermined period of time has passed after a respectively preceding notification about said event, said method further comprising detecting a motion of said mobile electronic device, wherein a detected presence or absence, respectively, of a motion determines at least one of a type of said notification and a length of said period of time.

9. The method according to claim 1, wherein said mobile electronic device is a foldable device comprising a primary display which is hidden when said device is folded and a secondary display which is not hidden when said device is folded, and wherein said notification is provided via said secondary display.

10. The method according to claim 1, wherein a provision of said notification can be switched off by a user of said mobile electronic device.

11. A mobile electronic device comprising:
a user interface; and
a processing component adapted to monitor whether a user checks an unchecked event, to monitor whether at least one further predetermined condition is met, and to cause a provision of a notification about said event via said user interface, whenever said at least one further predetermined condition is met while a user has not yet checked said event.

12. The mobile electronic device according to claim 11, wherein said processing component is adapted to monitor the time passing after a respective notification about an unchecked event, wherein said at least one further predetermined condition comprises that a predetermined period of time has passed after a respectively preceding notification about said event.

13. The mobile electronic device according to claim 11, further comprising at least one sensor monitoring a state of said mobile electronic device, wherein said at least one condition comprises the entry of a predetermined state of said mobile electronic device.

14. The mobile electronic device according to claim 13, wherein said at least one sensor comprises at least one of a motion detector detecting a motion of said mobile electronic device, a keypad detecting a user input, and a microphone detecting a change of a noise level surrounding said mobile electronic device.

15. The mobile electronic device according to claim 11, wherein said user interface comprises at least one of a visual output for outputting said notification as an optical notification, an audio output for outputting said notification as an audible notification and a vibration generator for providing said notification in form of a vibration of said mobile electronic device.

16. The mobile electronic device according to claim 11, wherein said processing component is adapted to cause the provision of a notification which differs from a first notification indicating the actual occurrence of said event.

17. The mobile electronic device according to claim 11, wherein said at least one further predetermined condition comprises a plurality of conditions, and wherein said processing component is adapted to cause a specific type of a notification to be provided in case a specific one of said further predetermined conditions is met.

18. The mobile electronic device according to claim 11, wherein said at least one further predetermined condition comprises that a predetermined period of time has passed after a respectively preceding notification about said event, said processing component being adapted to monitor the time passing after a respective notification about an event, wherein said mobile electronic device further comprises a motion detector detecting a motion of said mobile electronic device and informing said processing component about a detected presence or absence of a motion, and wherein said processing component is adapted to determine based on a detected presence or absence, respectively, of a motion at least one of a type of said notification and a length of said period of time.

19. The mobile electronic device according to claim 11, wherein said mobile electronic device is a foldable device comprising a primary display which is hidden when said device is folded and a secondary display which is not hidden when said device is folded, and wherein said processing component is adapted to cause a provision of said notification via said secondary display.

20. The mobile electronic device according to claim 11, further comprising input means enabling a user to enable and disable a provision of said notification about an event.

21. A software program product in which a software code for notifying a user of a mobile electronic device about an unchecked event is stored, said software code realizing the following steps when running in a processing component of said mobile electronic device:
monitoring whether a user checks said event;
monitoring whether at least one further predetermined condition is met; and
causing a provision of a notification about said event whenever said at least one further predetermined condition is met while a user has not yet checked said event.
